(19) United States
(12) Patent Application Publication
(10) Pub. No.: US 2017/0362045 A1
(43) Pub. Date: Dec. 21, 2017

(54) PAPER DISCHARGE APPARATUS, PAPER DISCHARGE METHOD AND PRINTING APPARATUS

(71) Applicant: TOSHIBA TEC KABUSHIKI KAISHA, Tokyo (JP)

(72) Inventor: Ken MASUDA, Mishima Shizuoka (JP)

(21) Appl. No.: 15/622,053

(22) Filed: Jun. 13, 2017

(30) Foreign Application Priority Data
Jun. 17, 2016 (JP) 2016-120728

(51) Int. Cl. B65H 29/62; B65H 7/02; B65H 79/00; B41J 13/10

(52) U.S. Cl. CPC B65H 29/62; B65H 79/00; B65H 7/02; B41J 13/106; B65H 2301/41896; B65H 2301/54

(57) ABSTRACT

A paper discharge apparatus includes a discharge port through which paper is discharged, a transport unit that transports the paper to the discharge port, a sensor disposed adjacent to the discharge port, and a controller. The controller is configured to control the transport unit such that a downstream side end of the paper is exposed through the discharge port, determine based on an output from the sensor whether or not the downstream side end of the paper is being pulled, and control the transport unit so as to change a transport mode of the paper according to a determination of whether or not the downstream end of the paper is being pulled.

### CROSS-REFERENCE TO RELATED APPLICATION

This application is based upon and claims the benefit of priority from Japanese Patent Application No. 2016-120728, filed Jun. 17, 2016, the entire contents of which are incorporated herein by reference.

### FIELD

An embodiment described herein relates generally to a paper discharge apparatus, a paper discharge method, and a printing apparatus.

### BACKGROUND

In recent years, a self-service cash register system has become widespread in which accounting processing of merchandise purchase is performed by a customer himself/herself at a checkout machine in a retail store such as a supermarket. When accounting processing of merchandise purchase is performed, a receipt printer that issues a receipt on which information of the merchandise purchased by a customer is printed, is used.

As a receipt printer, a paper discharge apparatus that includes a buffer space portion into which paper is fed in a loop shape, is used. The paper discharge apparatus discharges the paper received in the space portion through a discharge port after printing and cutting of the paper. According to the above paper discharge apparatus, printing and cutting of paper can be performed without being interrupted by a user's operation, and then the printed and cut paper can be reliably discharged.

On the other hand, in a case where a customer does not take the discharged paper immediately because of, for example, the user is bagging merchandise in a shopping bag or the like, there is a problem that the discharged paper may fall on the floor.

### DESCRIPTION OF THE DRAWINGS

FIG. 1 is a block diagram illustrating a configuration of a paper discharge apparatus, according to an embodiment.

FIG. 2 is a schematic diagram illustrating the internal configuration of the paper discharge apparatus.

FIG. 3A is a diagram depicting a state of a contact sensor and paper in a case where the paper is not pulled, and FIG. 3B is a diagram illustrating a state of a contact sensor and paper in a case where the paper is pulled.

FIG. 4 depicts a flowchart of control processing performed by the paper discharge apparatus.

FIG. 5 is a diagram depicting a state where the downstream end of paper is exposed from a discharge port.

### DETAILED DESCRIPTION

Embodiments provide a paper discharge apparatus and a paper discharge method capable of appropriately discharging paper according to a situation of a user who takes the paper from the paper discharge apparatus.

In general, according to one embodiment, a paper discharge apparatus includes: a discharge port through which paper is discharged, a transport unit that transports the paper to the discharge port, a sensor disposed adjacent to the discharge port, and a controller. The controller is configured to control the transport unit such that a downstream end of the paper is exposed through the discharge port, determine based on an output from the sensor whether or not the downstream end of the paper is being pulled, and control the transport unit so as to change a transport mode of the paper according to a determination of whether or not the downstream end of the paper is being pulled.

Hereinafter, a paper discharge apparatus and a paper discharge method according to an embodiment will be described with reference to the drawings. In the present embodiment, an example in which a receipt printer is a paper discharge apparatus will be explained. The receipt printer issues a receipt on which information of merchandise purchased by a customer (hereinafter, referred to as transaction information) or the like is printed.

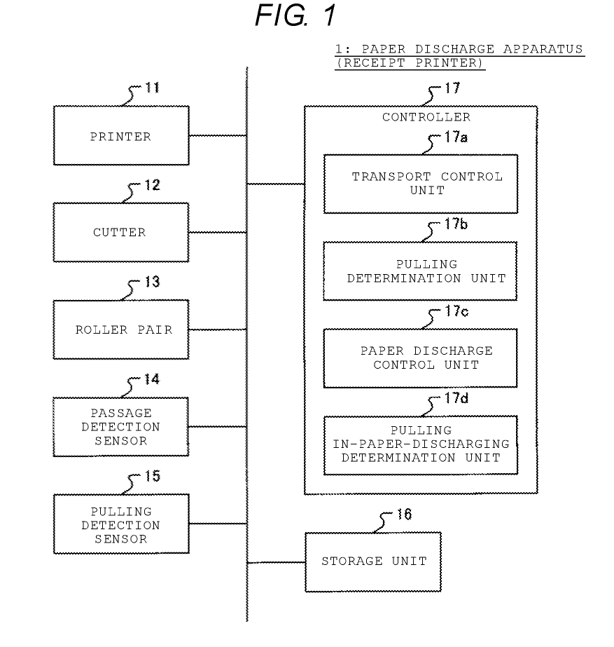

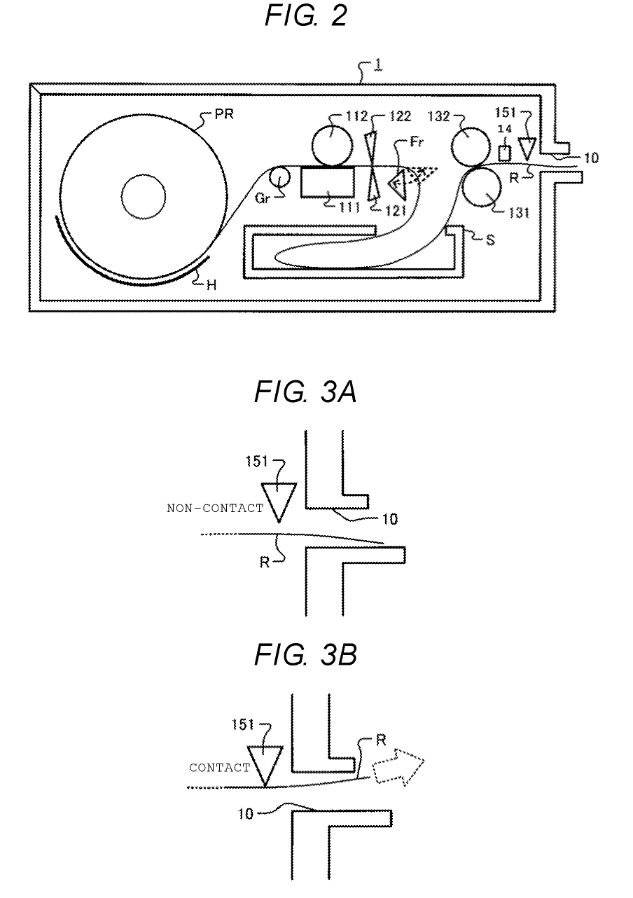

First, the configuration of a paper discharge apparatus 1 will be explained with reference to FIGS. 1 and 2. The paper discharge apparatus 1 prints the transaction information on paper R pulled out from a paper roll PR, and cuts an upstream end of a portion to be separately discharged of the paper R to discharge the portion of the paper R as a receipt. In addition, the paper discharge apparatus 1 exposes a downstream end of the cut portion of the paper R from a discharge port 10. The paper discharge apparatus 1 performs processing of changing a transport mode of the paper R, according to whether or not the downstream end of the exposed paper R is pulled by a user.

As illustrated in FIG. 1, the paper discharge apparatus 1 includes a printer 11, a cutter 12, a roller pair 13 (more generally, a transport unit), a passage detection sensor 14, a pulling detection sensor 15, a storage unit 16, and a controller 17.

The printer 11 prints the transaction information on the paper R. The printer 11 is provided on a transport path of the paper R, and is configured with a printer including a thermal head 111 and a platen roller 112.

As illustrated in FIG. 2, the thermal head 111 is provided downstream of a hopper H on which the paper roll PR is set, in the transport direction. The thermal head 111 prints the transaction information on the paper R by heating the paper R fed from the paper roll PR via a guide roller Gr.

The platen roller 112 is provided at a position opposite to the thermal head 111 across the transport path. The platen roller 112 rotates by driving a motor connected to a rotation shaft of the platen roller 112. The platen roller 112 feeds the paper R from the paper roll PR to the thermal head 111, and transports the paper R printed by the thermal head 111 to the downstream side in the transport direction.

The printed portion of the paper R passes through a first transport path which includes a paper receiving unit S or a second transport path which does not include the paper receiving unit S, under the control of the controller 17. A flapper Fr at which the transport path branches into the first transport path and the second transport path is provided downstream of the platen roller 112 in the transport direction. The flapper Fr is opened and closed under the control of the controller 17 based on an amount of transaction information printed on the paper R (length of an area to be printed in the transport direction) or the like. The paper R transported to the paper receiving unit S is received in the paper receiving unit S in a state where the paper R is curved in a loop shape as shown in FIG. 2.

The cutter 12 cuts the upstream side end of the portion of the paper R to be discharged. The cutter 12 cuts the paper R in a direction orthogonal to the transport direction of the paper R (longitudinal direction of the paper R). The cutter 12 is provided on the transport path of the paper R, and is configured with a cutter unit including a rotary blade cutter 121 and a fixed blade cutter 122.

The rotary blade cutter 121 is a cutter drum including a rotary blade on the outer circumference thereof, and is provided downstream of the thermal head 111 in the transport direction. The rotary blade cutter 121 is provided so that the rotation shaft of the drum is orthogonal to the transport direction of the paper R.

The fixed blade cutter 122 includes a fixed blade, and is provided at a position opposite to the rotary blade cutter 121 across the transport path. The paper R sandwiched between the rotary blade cutter 121 and the fixed blade cutter 122 is cut by driving the rotary blade cutter 121.

The roller pair 13 transports the paper R cut by the cutter 12, to the discharge port 10. The roller pair 13 is provided on the transport path of the paper R, and is configured with a driving roller 131 and a driven roller 132.

The driving roller 131 is provided downstream of the rotary blade cutter 121 in the transport direction. The driving roller 131 rotates by driving a motor connected to a rotation shaft of the driving roller 131.

The driven roller 132 is provided at a position opposite to the driving roller 131 across the transport path, and rotates in a direction opposite to the rotation direction of the driving roller 131 according to the rotation of the driving roller 131. The paper R sandwiched between the driving roller 131 and the driven roller 132 is fed toward the discharge port 10 by the rotation of the driving roller 131 and the driven roller 132.

The passage detection sensor 14 is configured with a paper detection sensor such as an optical sensor or a camera sensor. The passage detection sensor 14 is provided, for example, downstream of the driven roller 132 in the transport direction. The passage detection sensor 14 detects the presence or absence of the paper R which passed through the driven roller 132, and outputs the detection result to the controller 17.

The pulling detection sensor 15 is configured with a contact sensor 151 such as a leaf switch. The contact sensor 151 is provided at a position of the discharge port 10 or upstream of the discharge port 10 in the transport direction. For example, the contact sensor 151 is provided between the discharge port 10 and the passage detection sensor 14. As illustrated in FIGS. 3A and 3B, the contact sensor 151 is provided at a position at which the contact sensor 151 does not contact with the paper R when the paper R is not pulled by the user and the contact sensor 151 is brought into contact with the paper R when the paper R is pulled by the user. The contact sensor 151 detects contact or non-contact of the paper R, and outputs the detection result to the controller 17.

The storage unit 16 is configured with a read only memory (ROM), a flash memory, or the like. The storage unit 16 stores in advance a control program and various data which are used by the controller 17 for performing control processing to be described later. For example, the storage unit 16 stores a time (standby time) until discharge processing of the paper R is started after the downstream end of the paper R is exposed to the discharge port 10, control data for discharging the paper R at a high speed or at a low speed, and the like.

The controller 17 includes a central processing unit (CPU), a random access memory (RAM) functioning as a main memory of the CPU, a timer, and the like. When the power of the paper discharge apparatus 1 is turned on, the controller 17 reads and executes the control program from the storage unit 16 to function as a transport control unit 17a, a pulling determination unit 17b, a paper discharge control unit 17c, and a pulling in-paper-discharging determination unit 17d, and performs the control processing to be described later.

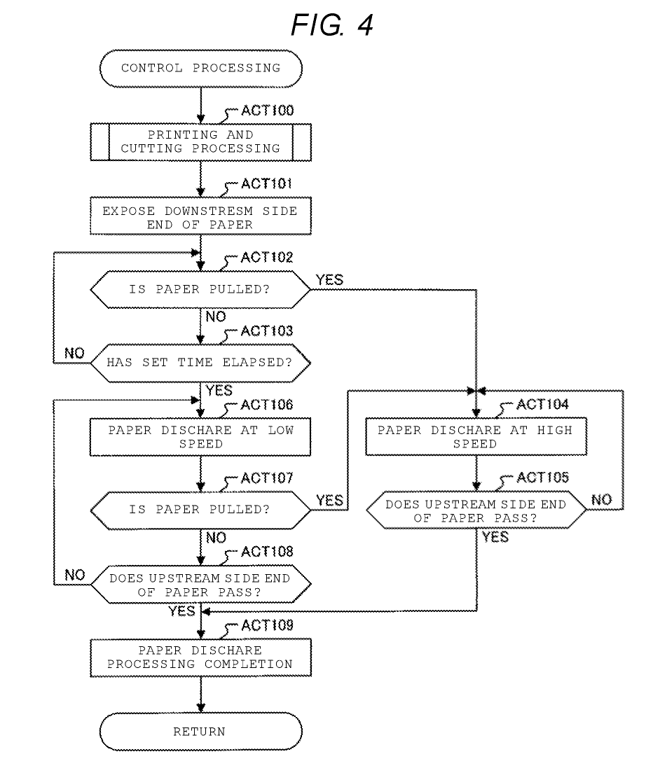

Hereinafter, in the paper discharge apparatus 1 with the above-described configuration, the control processing performed by the paper discharge apparatus 1 will be described with reference to FIG. 4.

The paper discharge apparatus 1 issues the receipt by performing the following processing.

(1) The paper discharge apparatus 1 prints the transaction information on the paper R, and cuts the paper R (ACT 100).

(2) The paper discharge apparatus 1 executes exposure processing to expose the downstream side end of the cut paper R through the discharge port 10 (ACT 101).

(3) The paper discharge apparatus 1 executes paper discharge processing for discharging the paper Rat a high speed or at a low speed (ACT 102 to ACT 109).

First, when receiving information of merchandise purchased by a customer (transaction information per transaction) from a terminal such as a point of sales (POS) register, the transport control unit 17a controls the thermal head 111 so as to print the transaction information on the paper R. In addition, the transport control unit 17a controls the platen roller 112 so as to feed the paper R printed by the thermal head 111. Accordingly, the transaction information is printed on the paper R pulled out from the paper roll PR, and the paper on which the transaction information is printed is transported to the downstream side in the transport direction.

After all of the transaction information per transaction is printed on the paper R, the transport control unit 17a controls the rotary blade cutter 121 so as to cut out a portion to be a receipt from the paper R. The rotary blade cutter 121 is driven under the control of the transport control unit 17a. Accordingly, the upstream side end of the paper R to be discharged is cut as a receipt by the rotary blade cutter 121 and the fixed blade cutter 122 (ACT 100).

Subsequently, the transport control unit 17a controls the driving roller 131 so as to expose the downstream side end of the paper R from the discharge port 10. For example, the transport control unit 17a determines whether or not the downstream side end of the paper R passed through the driven roller 132 based on the detection result of the passage detection sensor 14. Specifically, in a case where the detection result of the passage detection sensor 14 is changed from a state in which the paper R is not detected to a state in which the paper R is detected, the transport control unit 17a determines that the downstream side end of the paper R passed through the driven roller 132.

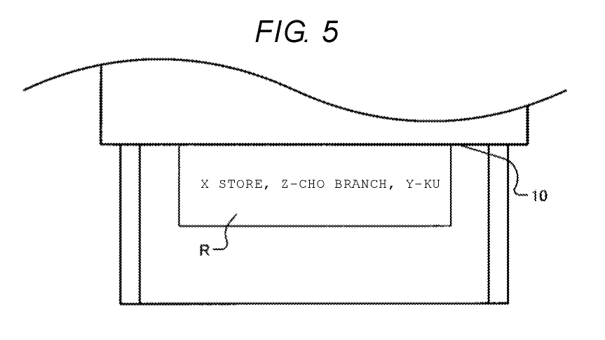

In a case where it is determined that the downstream side end of the paper R passed through the driven roller 132, the transport control unit 17a controls the driving roller 131 so as to expose the downstream side end of the paper R from the discharge port 10. Accordingly, as illustrated in FIG. 5, the downstream side end of the paper R is exposed from the discharge port 10 to such an extent that a user can pinch the paper R with fingertips (ACT 101).

As illustrated in FIGS. 3A and 3B, the contact sensor 151 detects contact or non-contact according to whether or not the paper R is pulled. The pulling determination unit 17b determines whether or not the downstream side end of the paper R is pulled according to the detection result of the contact sensor 151 (ACT 102). Specifically, in a case where non-contact is detected by the contact sensor 151, the pulling determination unit 17b determines that the paper R is not pulled by the user, and in a case where contact is detected by the contact sensor 151, the pulling determination unit 17b determines that the paper R is pulled by the user.

In addition, the pulling determination unit 17b determines whether or not a predetermined time stored in the storage unit 16 elapses (ACT 103). That is, until a predetermined time elapses after the downstream side end of the paper R is exposed to the discharge port 10, the pulling determination unit 17b repeatedly performs processing of determining whether or not the paper R is pulled (NO in ACT 102 and NO in ACT 103).

In a case where the pulling determination unit 17b determines that the paper R is pulled by the user (YES in ACT 102), the paper discharge control unit 17c controls the driving roller 131 so as to discharge the paper R at a high speed (for example, 40 ips (inch per second)) based on the control data, which is stored in the storage unit 16, for discharging the paper R at a high speed (ACT 104). Accordingly, the discharging operation of the paper R is started at a relatively high speed. In this case, since the user is already pinching the paper R with fingertips, even when the paper R is discharged at a high speed, the user can reliably receive the paper R.

Thereafter, the paper discharge control unit 17c determines whether or not the upstream side end of the paper R passed through the driven roller 132 based on the detection result of the passage detection sensor 14 (ACT 105). Specifically, in a case where the detection result of the passage detection sensor 14 is changed from a state in which the paper R is detected to a state in which the paper R is not detected, the paper discharge control unit 17c determines that the upstream side end of the paper R passed through the driven roller 132. The paper discharge control unit 17c controls the driving roller 131 so as to discharge the paper R at a high speed until the upstream side end of the paper R passes through the driven roller 132 (NO in ACT 105 and ACT 104).

In a case where it is determined that the upstream side end of the paper R passed through the driven roller 132, the paper discharge control unit 17c stops the driving roller 131 and ends the paper discharge processing (YES in ACT 105 and ACT 109).

Accordingly, the paper discharge processing of discharging the paper Rat a high speed is ended, and thereafter, the process returns to ACT 100.

On the other hand, in a case where the pulling determination unit 17b determines in ACT 103 that a predetermined time elapses (YES in ACT 103), the paper discharge control unit 17c controls the driving roller 131 so as to discharge the paper R at a low speed (for example, 4 ips to 10 ips) based on the control data, which is stored in the storage unit 16, for discharging the paper R at a low speed (ACT 106). For example, the discharge speed in ACT 106 is set to approximately ¼ to 1/10 of the discharge speed in ACT 104. Accordingly, discharge of the paper R is started at a speed lower than that of discharge of the paper R in ACT 104. In this case, since it takes time until the paper R is completely discharged, the user may not need to receive the paper R in a hurry.

In addition, when discharge of the paper R is performed at a low speed, the pulling in-paper-discharging determination unit 17d determines whether or not the paper R is pulled by the user according to the detection result of the contact sensor 151 (ACT 107). The pulling in-paper-discharging determination unit 17d repeatedly performs processing of determining whether or not the paper R is pulled by the user until the paper discharge control unit 17c determines that the upstream side end of the paper R passed through the driven roller 132 (NO in ACT 107 and NO in ACT 108). Further, during the repeated determining operation, the paper discharge control unit 17c controls the driving roller 131 so as to discharge the paper R at a low speed (ACT 106).

In a case where the pulling in-paper-discharging determination unit 17d determines that the paper R is pulled by the user (YES in ACT 107), the paper discharge control unit 17c proceeds to ACT 104 and controls the driving roller 131 so as to discharge the paper R at a high speed.

That is, in this case, a discharge speed of the paper R is switched from a low speed to a high speed. In this case, since the user is already pinching the paper R (receipt) with fingertips, even when the discharge speed of the paper R is switched from a low speed to a high speed, the user can reliably receive the paper R.

In addition, thereafter, the paper R is discharged at a high speed (NO in ACT 105 and ACT 104), and when the upstream side end of the paper R passes through the driven roller 132, the driving roller 131 is stopped (YES in ACT 105 and ACT 109).

As described above, the paper discharge processing of discharging the paper R with a discharge speed switched from a low speed to a high speed is ended, and thereafter, the process returns to ACT 100.

On the other hand, in a case where the paper discharge control unit 17c determines in ACT 108 that the upstream side end of the paper R passed through the driven roller 132, the paper discharge control unit 17c stops the driving roller 131 and ends the paper discharge processing (YES in ACT 108 and ACT 109). That is, in this case, until discharging operation of the paper R is ended after the discharging operation is started, the paper discharge processing is performed at a low discharging speed.

Accordingly, paper discharge processing of discharging the paper Rat a low speed is ended, and thereafter, the process returns to ACT 100.

As described above, a transport mode of the paper R is changed according to whether or not the downstream side end of the paper R that is exposed to the discharge port 10 is pulled, and the paper R is discharged at a high speed or a low speed. Therefore, the paper discharge apparatus 1 according to the present embodiment can appropriately discharge the paper R according to a situation of a user who receives the paper R.

In addition, in a case where the paper R is pulled by the user when the paper R is being discharged at a low speed, the paper discharge apparatus 1 can switch the discharge speed of the paper R from a low speed to a high speed, and thus appropriately change the discharge speed of the paper R according a user's operation.

When the position of the contact sensor 151 is changed, the pulling determination unit 17b may output a determination result opposite to that in the above-described embodiment, based on the detection result of the contact sensor 151. That is, the contact sensor 151 may be provided at a position at which the contact sensor 151 is brought into contact with the paper R when the paper R is not pulled by the user and the contact sensor 151 does not contact with the paper R when the paper R is pulled by the user, and the pulling determination unit 17b may determine that the paper R is not pulled by the user when the contact sensor 151 detects contact and determine that the paper R is pulled by the user when the contact sensor 151 detects non-contact.

In addition, in the above-described embodiment, the contact sensor 151 is described as an example of the pulling detection sensor 15. The pulling detection sensor 15 may be any device as long as the pulling detection sensor 15 can detect whether or not the paper R is pulled by the user, and an optical sensor, a camera sensor, a tension sensor, or the like may be used as the pulling detection sensor 15.

For example, in a case where the optical sensor is used as the pulling detection sensor 15, the pulling determination unit 17b may determine whether or not the paper R is pulled by the user based on a change in distance between the paper R and the optical sensor, which is detected by the optical sensor. In addition, in a case where the camera sensor is used as the pulling detection sensor 15, the pulling determination unit 17b may determine whether or not the paper R is pulled by the user based on a change in pixel values of the paper R, which are captured by the camera sensor. Further, in a case where the tension sensor is used as the pulling detection sensor 15, the pulling determination unit 17b may determine whether or not the paper R is pulled by the user based on a change in tension applied on the paper R, which is measured by the tension sensor.

In the above-described embodiment, in a case where the downstream side end of the paper R exposed to the discharge port 10 is not pulled until a predetermined time elapses (NO in ACT 103 illustrated in FIG. 4), the paper discharge control unit 17c controls the roller pair 13 so as to discharge the paper R at a low speed. Instead of performing this control, the paper discharge control unit 17c may control the roller pair 13 so as not to discharge the paper R. Alternatively, in this case, the paper discharge control unit 17c may perform processing of collecting or cutting the paper R, instead of controlling so as not to discharge the paper R.

In a case where the processing of collecting the paper R is performed, the paper discharge apparatus 1 is provided with, for example, a collection unit for collecting the paper R. In a case where the pulling determination unit 17b determines that the downstream side end of the paper R is not pulled, the paper discharge control unit 17c controls the driving roller 131 (roller pair 13) so as to transport the paper R exposed from the discharge port 10 to the collection unit, and stores the paper R in the collection unit.

In addition, in a case where the processing of cutting the paper R is performed, the paper discharge apparatus 1 is provided with a cutting unit for cutting the paper R. In a case where the pulling determination unit 17b determines that the downstream side end of the paper R is not pulled by the user, the paper discharge control unit 17c controls the driving roller 131 (roller pair 13) so as to transport the paper R exposed from the discharge port 10 to the cutting unit, and causes the cutting unit to cut the paper R transported to the cutting unit.

According to the paper discharge apparatus 1 with such a configuration, even in a case where a user leaves without receiving the paper R, it is possible to appropriately process the paper R to be discharged.

In the above-described embodiment, an example in which the paper discharge apparatus 1 is a receipt printer is described. The paper discharge apparatus 1 can be realized by various types of printers other than the receipt printer. For example, the paper discharge apparatus 1 may be a label printer.

In addition, the paper discharge apparatus 1 is described as an apparatus having a function of printing and cutting. Alternatively, the paper discharge apparatus 1 may be configured with an apparatus physically separated from an apparatus which performs printing and cutting of paper, as long as the paper discharge apparatus 1 can discharge paper.

Further, the paper set in the paper discharge apparatus 1 may be not paper roll but various standard sized paper such as A-sized paper or B-sized paper.

While a certain embodiment has been described, the embodiment has been presented by way of example only, and is not intended to limit the scope of the inventions. Indeed, the novel embodiment described herein may be embodied in a variety of other forms; furthermore, various omissions, substitutions and changes in the form of the embodiment described herein may be made without departing from the spirit of the inventions. The accompanying claims and their equivalents are intended to cover such forms or modifications as would fall within the scope and spirit of the inventions.

What is claimed is:

1. A paper discharge apparatus comprising:
a discharge port through which paper is discharged;
a transport unit that transports the paper to the discharge port;
a sensor disposed adjacent to the discharge port; and
a controller configured to control the transport unit such that a downstream side end of the paper is exposed through the discharge port, determine based on an output from the sensor whether or not the downstream side end of the paper is being pulled, and control the transport unit so as to change a transport mode of the paper according to a determination of whether or not the downstream end of the paper is being pulled.

2. The paper discharge apparatus according to claim 1, wherein
the sensor is positioned between the transport unit and the discharge port.

3. The paper discharge apparatus according to claim 1,
wherein the controller determines whether or not the downstream side end of the paper is pulled until a predetermined time elapses, and
wherein, in a case where the controller determines that the downstream side end of the paper is being pulled, the controller controls the transport unit so as to discharge the paper at a predetermined first speed, and in a case where the controller determines that the downstream side end of the paper is not being pulled until the predetermined time elapses, the controller controls the transport unit so as to discharge the paper at a second speed slower than the first speed.

4. The paper discharge apparatus according to claim 3,
wherein the controller further determines whether or not the paper is being pulled while the paper is being discharged at the second speed, and
wherein, in a case where the controller determines that the paper is being pulled, the controller controls the transport unit so as to discharge the paper at the first speed, and in a case where the controller determines that the paper is not being pulled, the controller controls the transport unit so as to discharge the paper at the second speed while maintaining the second speed.

5. The paper discharge apparatus according to claim 3,
wherein, the transport mode is a transport speed of the paper.

6. The paper discharge apparatus according to claim 1,
wherein the controller determines whether or not the downstream end of the paper is pulled until a predetermined time elapses, and
wherein, in a case where the controller determines that the downstream side end of the paper is being pulled, the controller controls the transport unit so as to discharge the paper at a predetermined first speed, and in a case where the controller determines that the downstream side end of the paper is not being pulled until the predetermined time elapses, the controller controls the transport unit so as to stop discharging of the paper.

7. The paper discharge apparatus according to claim 1,
wherein the sensor is a contact sensor disposed so as to face upper side surface of a predetermined portion of the paper, and
wherein the predetermined portion is adjacent to the discharge port.

8. A paper discharge method in a paper discharge apparatus comprising a discharge port through which paper is discharged, a transport unit that transports the paper to the discharge port, and a sensor disposed adjacent to the discharge port, comprising:
controlling the transport unit such that a downstream end of the paper is exposed through the discharge port;
determining based on an output from the sensor whether or not the downstream side end of the paper is being pulled; and
controlling the transport unit so as to change a transport mode of the paper according to a determination of whether or not the downstream side end of the paper is being pulled.

9. The method according to claim 8, wherein
the sensor is positioned between the transport unit and the discharge port.

10. The method according to claim 8, further comprising:
determining based on an output from the sensor whether or not the downstream end of the paper is pulled until a predetermined time elapses,
wherein, in a case where it is determined that the downstream side end of the paper is being pulled, controlling the transport unit so as to discharge the paper at a predetermined first speed, and in a case where it is determined that the downstream side end of the paper is not being pulled until the predetermined time elapses, controlling the transport unit so as to discharge the paper at a second speed slower than the first speed.

11. The method according to claim 10, further comprising:
determining whether or not the paper is being pulled while the paper is being discharged at the second speed,
wherein, in a case where it is determined that the paper is being pulled, controlling the transport unit so as to discharge the paper at the first speed, and in a case where it is determined that the paper is not being pulled, controlling the transport unit so as to discharge the paper at the second speed while maintaining the second speed.

12. The method according to claim 10,
wherein the transport mode determines a transport speed of the paper.

13. The method according to claim 8, further comprising:
determining whether or not the downstream end of the paper is pulled until a predetermined time elapses,
wherein, in a case where it is determined that the downstream side end of the paper is being pulled, the transport unit is controlled so as to discharge the paper at a predetermined first speed, and in a case where it is determined that the downstream side end of the paper is not being pulled until the predetermined time elapses, the transport unit is controlled so as to stop discharging of the paper.

14. The method according to claim 8,
wherein the sensor is a contact sensor disposed so as to face an upper side surface of a predetermined portion of the paper, and
the predetermined portion is adjacent to the discharge port.

15. A printing apparatus comprising:
a printer configured to form an image on paper;
a cutter configured to cut the paper on which the image is formed;
a discharge port through which paper is discharged;
a transport unit that transports the paper to the discharge port;
a sensor disposed adjacent to the discharge port; and
a controller configured to control the transport unit such that a downstream side end of the paper is exposed through the discharge port, determine based on an output from the sensor whether or not the downstream side end of the paper is being pulled, and control the transport unit so as to change a transport mode of the paper according to a determination of whether or not the downstream side end of the paper is being pulled.

16. The printing apparatus according to claim 15, wherein
the sensor is positioned between the transport unit and the discharge port.

17. The printing apparatus according to claim 15,
wherein the controller determines whether or not the downstream end of the paper is pulled until a predetermined time elapses, and
wherein, in a case where the controller determines that the downstream side end of the paper is being pulled, the controller controls the transport unit so as to discharge the paper at a predetermined first speed, and in a case where the controller determines that the downstream side end of the paper is not being pulled until the predetermined time elapses, the controller controls the transport unit so as to discharge the paper at a second speed slower than the first speed.

18. The printing apparatus according to claim 17,
wherein, the controller further determines whether or not the paper is being pulled while the paper is being discharged at the second speed, and
wherein, in a case where the controller determines that the paper is being pulled, the controller controls the transport unit so as to discharge the paper at the first speed, and in a case where the controller determines that the paper is not being pulled, the controller controls the transport unit so as to discharge the paper at the second speed while maintaining the second speed.

19. The printing apparatus according to claim 17,
wherein the transport mode determines a transport speed of the paper.

20. The printing apparatus according to claim 15,
wherein the controller determines whether or not the downstream side end of the paper is pulled until a predetermined time elapses, and
wherein, in a case where the controller determines that the downstream side end of the paper is being pulled, the controller controls the transport unit so as to discharge the paper at a predetermined first speed, and in a case where the controller determines that the downstream side end of the paper is not being pulled until the predetermined time elapses, the controller controls the transport unit so as to stop discharging of the paper.
